(19) United States
(12) Patent Application Publication
(10) Pub. No.: US 2008/0120256 A1
(43) Pub. Date: May 22, 2008

(54) APPARATUS AND PROCESS FOR INCREASING THE CONSUMER AWARENESS OF CONSUMER PRODUCTS

(76) Inventors: Adam Jeffrey Lisook, Cincinnati, OH (US); Ryan Matthew Fitzsimons, Manchester, NH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/924,765

(22) Filed: Oct. 26, 2007

Related U.S. Application Data
(60) Provisional application No. 60/860,180, filed on Nov. 20, 2006.

(51) Int. Cl. G06Q 90/00

(52) U.S. Cl. 705/500

(57) ABSTRACT

The present invention provides a bank of rooms having a thematic relationship to a consumer product. The bank of rooms is provided with a plurality of individual rooms. Each of the rooms has fixtures disposed therein. The fixtures are thematically related to the consumer product. The fixtures are arranged within each of the individual rooms so as to allow a consumer to interact with the consumer product.

### CROSS REFERENCE TO RELATED APPLICATIONS

This application claims the benefit of U.S. Provisional Application No. 60/860,180 filed Nov. 20, 2006.

### FIELD OF THE INVENTION

The present invention relates generally to an apparatus, locations and a process suitable for increasing the consumer awareness of consumer products. More particularly, the present invention provides for the development of locations and processes for increasing the conversion of consumers having varied brand and/or consumer related product allegiances to a preferred brand and/or related consumer product.

### BACKGROUND OF THE INVENTION

A goal of consumer products manufacturers is to increase the brand equity of their saleable products. Among the traditional methods to increase brand equity is to provide for the advertising of the consumer products in the mainstream media. In addition to mainstream media advertising, advertising at a point of use where the consumer is essentially a “captive audience” can provide for a secondary form of advertising. By way of example, billboard displays, commercial advertising, poster, and the like can provide substantial economic value as a venue for advertising. In such a situation, not only is the user alone and absent of distractions but such advertising can be targeted to a known occupation, by gender, or by income level.

The application of advertising in conjunction with public facilities is addressed in U.S. Pat. Nos. 6,385,796 and 6,477,718. Likewise, advertising during the use of various public facilities is discussed in U.S. Publication No. 2004/0201488 A1.

However, what would be useful would be to provide for advertising of a desired consumer product and in conjunction provide consumers with a sample of the desired consumer product in order to provide an equity boost. Providing such consumer products directly into the hand of a consumer in a publicly available location can provide for the increase in sales of the desired consumer product at the expense of the net sales of a corresponding competitive consumer product.

Thus, if properly structured, such advertising and actual hands-on consumer contact with the desired consumer product can generate substantial revenue. In particular, it would be advantageous to provide for a public rest facility that provides the target consumer with a sampling of the desired consumer products in an environment where the use of the desired consumer product increases the consumer's comfort. This can then drive the consumer to purchase the desired consumer product over corresponding competitive product at the point of sale.

### SUMMARY OF THE INVENTION

The present invention provides for a bank of rooms having a thematic relationship to a consumer product. The bank of rooms comprises a plurality of individual rooms. Each of the rooms has at least one fixture disposed therein. The at least one fixture is thematically related to the consumer product and is arranged within each of the individual rooms so as to allow a consumer to interact with the consumer product.

The present invention also provides for a room having a thematic relationship to a consumer product. The room has at least one fixture disposed therein. The at least one fixture is thematically related to the consumer product and is arranged within the room so as to allow a consumer to interact with the consumer product.

### BRIEF DESCRIPTION OF THE DRAWINGS

FIG. 1 is an exemplary embodiment of a room having fixtures disposed therein in accordance with the present invention;

FIG. 2 is an exemplary embodiment of a bank of rooms;

FIG. 3 is an exemplary embodiment of an open central area suitable for use in conjunction with a bank of rooms; and,

FIG. 4 is an exemplary embodiment of a consumer accessible facility and/or a central retail area suitable for use in conjunction with a bank of rooms and/or an open central area.

### DETAILED DESCRIPTION OF THE INVENTION

The present invention is directed toward a merchandising system 10 suitable for use in targeting a consumer. The merchandising system 10 can provide for an ability to increase the sales of a desired consumer brand and/or consumer product over a corresponding competitive consumer brand or consumer product by providing the consumer with an opportunity to use and experience a desired consumer product. The merchandising system 10 is typically provided with a room 12 having at least one fixture 14 disposed therein in which the consumer may use and experience a desired consumer product 26.

A prominent way in which merchandising system 10 may provide additional revenues to the brand utilizing the merchandising system 10 is through what is known to those of skill in the art as ‘conversion.’ As such, conversion is expected that a consumer-oriented experience provided by the merchandising system 10, as well as the consumer product 26 trial created by the target consumer's interaction with consumer product 26 in a room 12, could result in a significant portion of previously non-loyal consumers who utilize the merchandising system 10 to be persuaded to become a consumer of the brand supporting consumer product 26. This consumer relationship can be created and augmented by the exemplary, but non-limiting, embodiments discussed infra of the items and activities mentioned previously in this document, including for example, a dance floor to entertain children, a photo opportunity, interaction with the brand's mascot (if applicable), and the surprise and delight of the consumer product 26 or room 12 benefit itself.

It should be noted that the consumer relationship that is created by use of the merchandising system 10 disclosed herein may be long-term in nature, and thus very valuable to the brand supporting consumer product 26. It would be known to those of skill in the art that conversion (i.e., the percentage of previously non-loyal consumers who move to being consumers of the brand in question as a result of their interactions with the brand at the merchandising system 10) could be in the range of 10-15%. This value can be measured through entrance and exit polls of consumers using the merchandising system 10. By way of non-limiting example, a consumer is interviewed as they are entering the consumer accessible facility housing merchandising system 10 and states that they do not currently buy the brand's products or, in particular, consumer product 26. A period of time after using merchandising system 10, that consumer can be contacted and asked a few questions about their experience using the merchandising system 10 and whether they have bought any of the brand's products, or consumer product 26, since their visit. If the answer is yes, then they can be considered as being converted. This conversion, which by its very nature creates more trial for the brand's products, or consumer product 26, can be vital to a brand's health.

In addition to revenues generated by such conversion, a brand utilizing the merchandising system 10 could accompany the merchandising system 10 with large-scale media support. This media support could be a fundamental and/or important aspect to the merchandising system's 10 financial return. Revenue could be gained through media coverage when a prospective consumer comes into contact with a mention about the merchandising system 10, either on TV, in print, on the radio, on a website, or in any other medium in which media impressions might be created, and decides to try the consumer product 26 based upon this interaction. Coupling merchandising system 10 with many media impressions can cause the brand or the consumer product 26 to experience significant volume and/or revenue lifts based upon these impressions. It should be known to those of skill in the art that, for example, the impressions created by billboards or other outdoor advertising can similarly create volume and revenue for the brand or the consumer product 26 by introducing the consumer product 26 to a consumer (through messaging about the event) and/or keeping the brand or consumer product 26 top-of-mind for that consumer.

Such a merchandising system 10 can provide a scheme within virtually any type of establishment that can be directed toward most, if not all, consumer products and virtually any type of consumer, thereby providing for a pleasant consumer experience. Any particular type of consumer (also referred to as a target consumer) can be characterized according to age, gender, race, or personal interests, such as pets, sports, automotive needs, gardening, and the like. Thus, the disclosed merchandising system 10 can be directed towards and used in conjunction with retail establishments harboring to such personal interests to create a merchandising system 10, including grocery stores, department stores, supermarkets, superstores, wholesale clubs, stand-alone establishments, and the like, and combinations thereof.

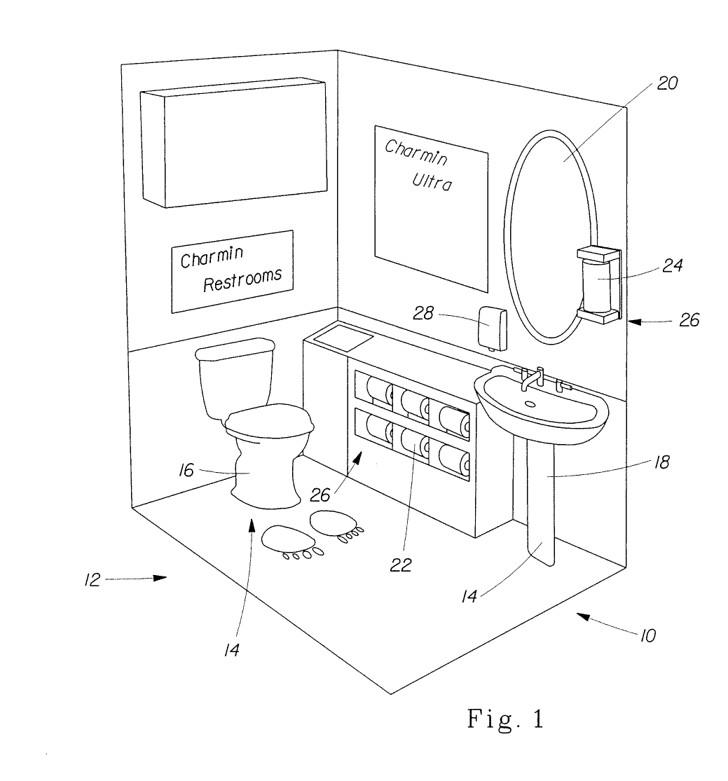

An exemplary layout of a room 12 suitable for use with a merchandising system 10 is shown in FIG. 1. As depicted in FIG. 1, the room 12 is shown as a typical bathroom. However, one of skill in the art would understand that room 12 can be provided as a kitchen, a dining room, a living room, bedroom, a day room, a sun room, a garage, or any other typical room associated with a house and not differ from the scope of the present invention. Room 12 can be provided with fixtures 14 that are preferably thematically related to the consumer product 26 of interest. For example, if the room 12 is provided as a bathroom, fixtures 14 can comprise a sink 18, a stool and/or commode 16, a mirror 20 and the like. These fixtures 14 would be found in a typical consumer's bathroom. Consumer products 26 can be provided in the exemplary room 12 in the form disposable paper products, such as bath tissue 22, paper toweling 24, facial tissues and the like, as well as soaps 28 and the like, and combinations thereof. However, depending upon the consumer product 26 to be used in conjunction with the room 12, the consumer product 26 may also be a cosmetic product, grocery, personal hygiene product, pharmaceutical, automotive part, clothing, toy, electronics, and the like, and combinations thereof.

In addition to the bath tissue 22 and paper toweling 24 described herein, other web substrates may be suitable for use with the present invention as consumer product 26. As used herein, a web substrate is a flexible sheet, web material, or a web segment that may be useful for household chores, personal care, health care, food wrapping, cosmetic application or removal, and the like. Non-limiting examples of suitable substrates useful for the present invention include non-woven substrates, woven substrates, hydroentangled substrates, air-entangled substrates, paper substrates (such as tissue, toilet paper, or paper towels), wax paper substrates, coformed substrates, wet wipes, film or plastic substrates (such as those used to wrap food), metal substrates (such as aluminum foil), and combined substrates (such as diapers, feminine care products, and the like). Furthermore, laminated or plied together substrates of two or more layers of any of the preceding substrates are suitable for use in the present invention.

In use, a consumer may enter an exemplary room 12 and make use of the fixtures 14, as required. After use of the fixtures 14, a consumer may then complete his/her use of the exemplary room 12 by use of the herein described consumer product 26.

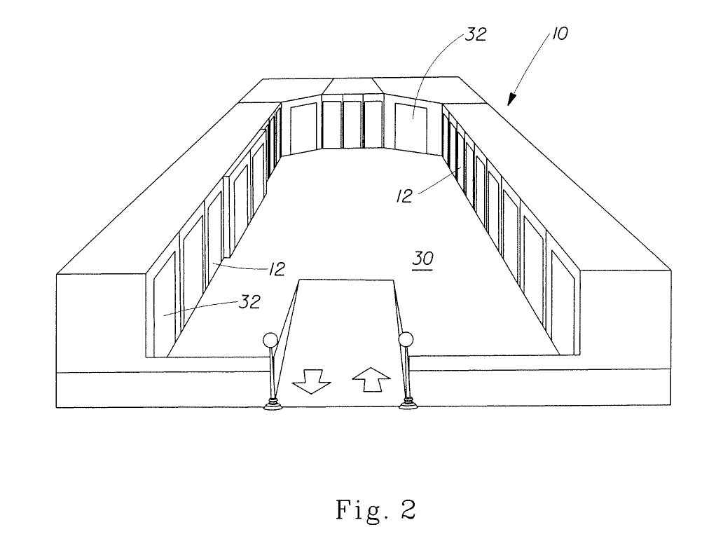

As shown in FIG. 2, merchandising system 10 can comprise a bank of rooms 12. A bank of rooms may comprise a plurality of rooms disposed adjacent one another. Alternatively, a bank of rooms may comprise a plurality of discrete rooms 12 disposed about an open central area 30. The bank of rooms 12 can be provided as bounding the open central area 30. Each of the individual rooms 12 of the bank of rooms 12 can be provided with ingress and egress through individualized doors 32 that allow access to the inner sanctum of each room 12 from the open central area 32 and also provide access to allow for re-stocking and/or cleaning a room 12. Likewise, open central area 30 can be provided with the capacity for ingress and egress.

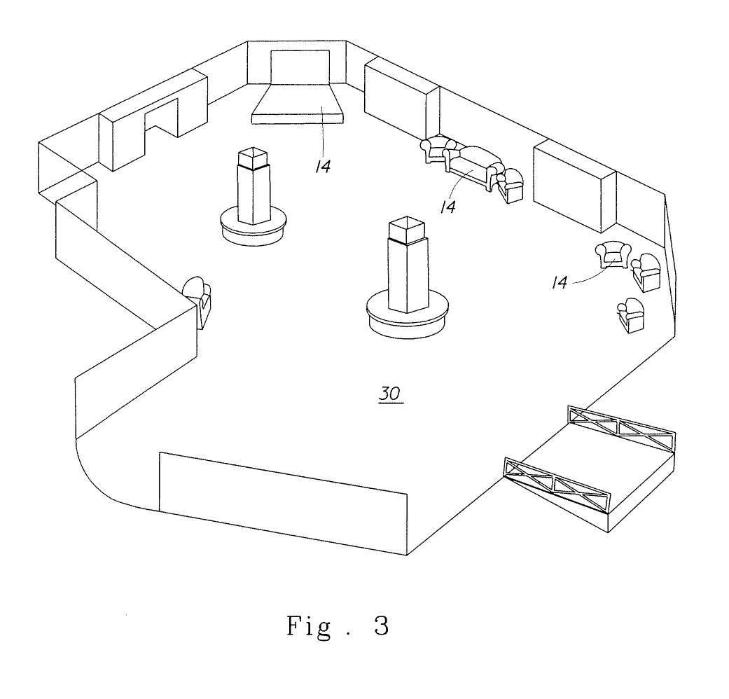

As shown in FIG. 3, an alternative embodiment of an open central area 30 can be provided with fixtures 14 in the form of sofas, chairs, beds, and the like, in order to provide for additional consumer comfort (consumer comfort fixtures). It is believed that the provision of fixtures 14 within an open central area 30, such as those depicted in FIG. 3, can also contribute to the overall consumer comfort while experiencing the desired consumer product 26. Further, it is believed that the presence of fixtures 14 within the open central area 30 can also provide an increase to the net sales of the desired consumer product 26 by providing an association of the consumer product 26 with the additional “creature comforts” necessary by the consumer prior to, or immediately after, use of an individual room 12 having consumer product 26 therein.

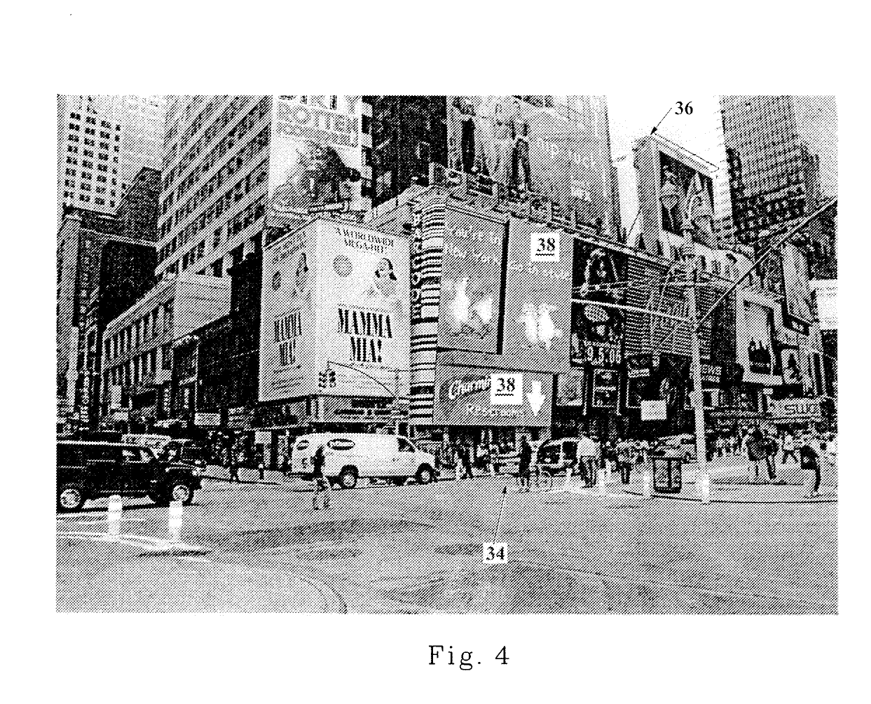

As shown in FIG. 4, an exemplary bank of rooms 10 and open central area 30 can be provided in a consumer accessible facility 34. In a preferred embodiment, the consumer accessible facility 34 is provided within a central retail area 36. Such exemplary central retail areas can provide close proximity to movie theatres, restaurants, and other various retail shops and/or shopping facilities. In a preferred embodiment, such a central retail area 36 is provided in a location having sufficient foot traffic. In a preferred embodiment of the present invention, a preferred central retail area 30 could be located in the Times Square area of New York City. It is believed that Times Square provides at least about 1.5 million visitors per day, and such a location could provide additional impetus to the success of the merchandising system 10 disclosed herein. Other regions suitable for use as a central retail area 36 may include, but not be limited to, Chicago's Magnificent Mile, San Francisco's Fisherman's Wharf, and the like. However, if so desired, such a merchandising system 10 as that envisioned by the present invention would not necessarily require the use of a high foot traffic region, and other locations may therefore be suitable for use. In any regard, it is preferred that such a central retail area 36 suitable for use with the present invention not have any, or have insufficient, facilities thematically related to, or suitable for use, with the consumer product 26. In other words, any area having a need (well publicized or otherwise) that may be connected with the consumer products 26 envisioned for use with the merchandising system 10 described herein can be suitable for use with the present invention.

Other considerations that may be used for the determination of a suitable central retail area 36 for use with the merchandising system 10 of the present invention may include but not be limited to 1) the number of visitors to the central retail area 36, 2) the family friendly nature of a central retail area 36, 3) the need for a service related to the use of the consumer product 26 within the central retail area 36, and the like. Additionally, it may be advantageous to consider the possibility of including billboard space 38 that is available proximate to and/or adjacent to the consumer accessible facility 34. Other considerations suitable for use in determining a suitable location for the merchandising system 10 of the present invention can include the logistics of the space available, the foot traffic in the central retail area 36 and proximate to the consumer accessible facility 34, the visibility of the consumer accessible facility 34, the cost of a consumer accessible facility 34, any lease terms required to obtain the use of the consumer accessible facility 34, and the like, and combinations thereof.

It is believed that the number of rooms 12 provided in a bank of rooms located within a consumer accessible facility 34 should provide sufficient opportunity for consumers to generate an opinion after use of a desired consumer product 26. In some situations, it may be prudent to provide a smaller number of rooms 12 if the consumer accessible facility 34 is located within a central retail area 36 that is small. Such a venue may have at least about three rooms 12 disposed in a bank of rooms. However, in other cases it may be prudent to provide for a large number of rooms 12 within a consumer accessible facility 34 if the central retail area 36 is correspondingly large. In one exemplary, but non-limiting, embodiment for a central retail area 36 located in New York's Times Square, it is believed that at least about twenty rooms 12 can be provided within a consumer accessible facility 34. While this was found to provide an adequate usage of a desired consumer product 26, it is not steadfast that at least about 20 rooms be used—indeed, more or less rooms 12 may be suitable for use. Without desiring to be bound by theory, it is believed that the use of the merchandising system 10 of the present invention can allow consumers to reflect positively upon the desired consumer product 26 while using the desired consumer product 26 in a positive, comfortable surrounding when it is least expected and likely, needed most. Such positive reflection upon consumer product 26 is believed to create a positive association between the desired consumer product 26 and the consumer and can provide for an increase of the sales of the desired consumer product 26 over a competitive product due to this association.

Likewise, it was found that it can be desirable to provide a bank of rooms 12 within a consumer accessible facility 34 located within a central retail area 36 that is open during times of peak consumer traffic within the central retail area 36. Such peak traffic may be driven by considerations such as holiday seasons (i.e., Thanksgiving, Christmas, New Year, and the like), as well as the time of day (i.e., morning, afternoon, and/or evening). Adjusting the accessibility of the rooms 12 disposed within the consumer accessible facility 34 to accommodate such peak traffic and/or idealized peak times can provide for additional consumer input if the decision of whether the desired consumer product 26 is more desirable than corresponding competitive product due to the influence of the merchandising system 10.

It was also surprisingly found that a consumer accessible facility 34 can be located in a central retail area 36 having sufficient window space. Without desiring to be bound by theory, it was found that associating a sufficient amount of window space with consumer accessible facility 34 can provide consumers with a look into the consumer accessible facility 34 in order to provide a degree of intrigue thus increasing the experience afforded the consumer with regard to the desired consumer product 26. Likewise, it was surprisingly found that the application of billboard space 38 and/or other signage proximate to the consumer accessible facility 34 can drive consumer interest in use of the consumer accessible facility 34.

It was also found that the consumer accessible facility 34 having an open central area 30 can be provided with consumer product branding consistent with the consumer products 26 provided within rooms 12. Thus, providing the open central area 30 with additional color and/or brand information consistent with consumer product 26 can provide the consumer with additional reinforcement for the need to purchase the desired consumer product 26 over the corresponding competitive product.

Likewise, the open central area 30 can be provided with additional fixtures 14, such as sofas, chairs, beds, televisions, TV monitors, computer stations and the like that can provide an additional “zone of relaxation” for the consumer. Such additional fixtures 14 can also provide a medium for additional brand commercial advertisements and other brand related content consistent with the consumer product 26 in audio and/or video formats. Additionally, certain regions of the open central area 30 can be set aside for areas for families to be provided entertainment by any consumer product 26 brand related mascots, regions for photographic opportunity, scenic backdrops, floor observation, and the like. Without desiring to be bound by theory, it is believed that providing entertainment in this manner can also create and foster a positive association between the desired consumer product 26 and the consumer and can provide for an increase in future sales of the desired consumer product 26 over a competitive product due to this association.

Additionally, other related consumer products 26 associated with the commercial entity providing such rooms 12 within a consumer accessible facility 34 can be provided for use. By way of non-limiting example, if a consumer product 26 associated with room 12 is provided as a disposable paper product (for example, Charmin® bath tissue and/or Bounty® paper toweling available from The Procter & Gamble Company, Cincinnati, Ohio), additional consumer products 26 available from The Procter & Gamble Company (i.e., Puffs® facial tissue, Safeguard® soap, Pampers® diapers, Mr. Clean® detergent, Tide® laundry detergent, Ivory® soap, Pringles® potato chips, and the like) can be provided for review and/or potential use by a consumer.

In connection with the merchandising system 10 of the present invention, one of skill in the art will understand that a website can be developed suitable for use with the present invention. Such a website can provide, by way of non-limiting example, directions to the consumer accessible facility 34, hours of operation of the consumer accessible facility 34, maps to the consumer accessible facility 34, as well as interactive elements, such as an on-line posting of consumers that have accessed the consumer accessible facility 34. Likewise, such a website can be provided with a record of the number of consumers who have accessed the consumer accessible facility 34, as well as information relevant to each consumer accessing the consumer accessible facility 34, such as their home state and/or country. Likewise, the fixtures 14 located within the consumer accessible facility 34 or the open central area 30 can be adopted to display this information.

Referring again to FIG. 1, in a preferred embodiment, each room 12 is provided with fixtures 14 that a consumer is likely to find in his/her corresponding room within his/her house. In a preferred embodiment, a room 12 positioned as a restroom would be provided with full-sized porcelain stools, porcelain sinks, and modern vanity cabinets. The room 12 may also comprise counter-tops, bidets, bathtubs, and showers. It is believed that providing fixtures of such quality can provide the consumer with a branded experience that has as many, if not more, of the comforts of his/her own home. In any regard, the branding should be meant to be noticeable but not presented in an experience that would be deemed overwhelming by a consumer. It is also preferred that some of the rooms be provided as handicapped accessible (ADA compliant) and/or preferably provided with changing facilities for infants (i.e., baby-changing stations, a fold-down platform, etc.) in order to provide for a positive consumer experience.

A preferred room 12 in accordance with the present invention can also be provided with art-work in order to enhance the desired consumer product 26 experience. It has been found that providing a room 12 with a mural depicting a well-known location or place can provide the consumer with a positive experience. By way of non-limiting example, a mural may provide a pictorial representation of city scenes, city sky-lines, locations of historical significance, combinations thereof, and the like. Likewise, the art-work provided within a room 12 may include sculptures, wall-mountings, decorative items, wall paper, paint, combinations thereof, and the like. In any regard, it is desirable to provide room 12 with fixtures 14 and any various art-works needed to provide the consumer with a positive experience from the use of merchandising system 10.

It is preferred that each room 12 be fully staffed by personnel who preferably clean each room 12 within consumer accessible facility 34 after each use. It is believed that such a cleaning after each use can provide significant branding equity and provide additional comfort, as well as a delightful experience to each of the consumers using a consumer product 26. Likewise, any staffing provided in such a consumer accessible facility 34 could be provided with uniforms consistent with the brand and/or the consumer product 26 provided within each room 12 of consumer accessible facility 34.

In a preferred, but non-limiting embodiment, it is preferred that samples of consumer product 26, or other consumer-useful goods, are given to consumers as they exit the consumer accessible facility 34. By way of non-limiting example, a consumer may be given brand-designed maps of the location where the consumer accessible facility 34 is located for their use and to have as souvenirs of the consumer's time spent at the consumer accessible facility 34. It is believed that such a promotion may not only spur further trial of the consumer product 26 (in the case of a sample), but continue to perpetuate positive feelings and solid connection generated and/or built between the consumer product 26 and the consumer.

In addition, the merchandising system 10 may include offer merchandise for sale inside the open central area 30 of consumer accessible facility 34, outside consumer accessible facility 34 or proximate to consumer accessible facility 34. Preferably, the merchandise offered for sale is brand-related to consumer product 26. It is believed that offering brand-related merchandise for sale can allow the consumer to bring the experience of the consumer accessible facility 34 home with them. By way of non-limiting example, such merchandise offered for sale may not be the actual consumer product 26 represented by the brand and/or thematically tied to room 12 or consumer accessible facility 34, but rather brand-related paraphernalia such as, but not limited to, clothing items, stuffed animals, toys, trinkets, souvenirs, and the like, and combinations thereof. Offering such merchandise for sale could create additional profits for the brand using merchandising system 10. In any regard, the extension of the relationship with the consumer, their home, and lives can provide additional impetus for the consumer to elect the preferred product over the alternatives.

Likewise, coincident with the merchandising system 10 disclosed herein, one of skill in the art would understand that providing significant media relations can likewise increase the brand experience of the consumer when it is connected with the use of consumer product 26. By way of non-limiting examples, commercial advertising (as well as media exposure to an event such as the development of a consumer accessible facility 34) can further provide additional reinforcement to a potential consumer of consumer product 26 in order to drive the consumer to use the desired consumer product 26 and disassociate the consumer with the use of corresponding competitive products. One of skill in the art will also understand that the use of street teams, personnel dressed in costumes, and the like can be used on an as-needed basis in order to drive consumer interest in use of the consumer accessible facility 34 having rooms 12 and consumer product 26 disposed therein.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

Any dimensions and/or numerical values disclosed herein are not to be understood as being strictly limited to the exact dimension and/or numerical values recited. Instead, unless otherwise specified, each such dimension and/or numerical value is intended to mean that recited dimension and/or numerical value and a functionally equivalent range surrounding that dimension and/or numerical value. For example, a dimension disclosed as “40 mm” is intended to mean “about 40 mm”.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A bank of rooms having a thematic relationship to a consumer product, said bank of rooms comprising a plurality of individual rooms, each of said rooms having at least one fixture disposed therein, said at least one fixture being thematically related to said consumer product, said at least one fixture being arranged within each of said individual rooms so as to allow a consumer to interact with said consumer product.

2. The bank of rooms according to claim 1, wherein said bank of rooms is located within a consumer accessible facility.

3. The bank of rooms according to claim 2, wherein said consumer accessible facility is located within a central retail area.

4. The bank of rooms according to claim 2, wherein said consumer accessible facility is located within a retail shopping facility.

5. The bank of rooms according to claim 2, wherein said consumer accessible facility comprises an open central area.

6. The bank of rooms according to claim 5, wherein said open central area comprises at least a consumer comfort fixture.

7. The bank of rooms according to claim 1, wherein said bank of rooms comprises at least three rooms.

8. The bank of rooms according to claim 1, wherein a first of said individual rooms is disposed adjacent to a second of said individual rooms.

9. The bank of rooms according to claim 8, wherein said bank of rooms comprises twenty rooms.

10. The bank of rooms according to claim 1, wherein at least a first of said individual rooms is provided with a mural.

11. The bank of rooms according to claim 10, wherein said mural is selected from a group consisting of city scenes, city skylines, locations of historical significance, and combinations thereof.

12. The bank of rooms according to claim 1, wherein said at least one fixture is selected from a group consisting of stools, sinks, counters, baby changing stations, bidets, bathtubs, showers, cabinets, and combinations thereof.

13. The bank of rooms according to claim 12, wherein said at least one fixture is a stool and a sink.

14. The bank of rooms according to claim 1, wherein said consumer product is a disposable paper product.

15. The bank of rooms according to claim 14, wherein said disposable paper product is selected from a group consisting of bath tissues, paper toweling, facial tissue, and combinations thereof.

16. The bank of rooms according to claim 1, wherein each of said individual rooms comprises an area sufficiently large to allow for restocking and a door to access said an open central area.

17. A room having a thematic relationship to a consumer product, said room having at least one fixture disposed therein, said at least one fixture being thematically related to said consumer product, said at least one fixture being arranged within said room so as to allow a consumer to interact with said consumer product.

18. The room according to claim 17, wherein said room is located within a consumer accessible facility.

19. The room according to claim 17, wherein said at least one fixture is selected from a group consisting of stools, sinks, counters, baby-changing stations, bidets, bathtubs, showers, and cabinets, and combinations thereof.

20. The room according to claim 17, wherein said consumer product is a disposable paper product.
